(19) United States
(12) Patent Application Publication
(10) Pub. No.: US 2014/0352734 A1
(43) Pub. Date: Dec. 4, 2014

(54) METHOD FOR CLEANING CHLORINE MEMBRANE ELECTROCHEMICAL CELL

(71) Applicant: DOW GLOBAL TECHNOLOGIES INVESTMENTS LLC, Midland, MI (US)

(72) Inventors: Andrew Hughes, Lake Jackson, TX (US); Christopher M. Tyree, Clute, TX (US); Robert E. Aikman, Lake Jackson, TX (US); James F. Heller, Lake Jackson, TX (US); Charles E. Lyon, Lake Jackson, TX (US); Felipe A. Donate, Midland, MI (US); Harry S. Burney, San Antonio, TX (US); Allen D. Blackmon, Danville, AZ (US)

(73) Assignee: Dow Global Technologies LLC, Midland, MI (US)

(21) Appl. No.: 14/369,762

(22) PCT Filed: Jan. 4, 2013
(86) PCT No.: PCT/US2013/020351

§ 371 Date: Jun. 30, 2014

Related U.S. Application Data
(60) Provisional application No. 61/583,766, filed on Jan. 6, 2012.

(51) Int. Cl. C25B 15/00; C11D 7/50; C25B 1/34

(52) U.S. Cl. CPC C25B 15/00; C25B 1/34; C11D 7/5022
USPC 134/22.19; 134/42; 134/26; 510/109

(57) ABSTRACT

The present disclosure provides a method for cleaning a chlorine membrane electrochemical cell.

### FIELD

The present disclosure relates to a method for cleaning a chlorine membrane electrochemical cell.

### BACKGROUND

Chlorine and sodium hydroxide can be generated from an aqueous sodium chloride solution, also referred to as brine, by electrolysis. Typically, a chlorine membrane electrochemical cell is a two-compartment electrolytic cell having an anode compartment containing anolyte, and a cathode compartment containing catholyte. The two compartments are separated by a polymer membrane, such as a cation exchange membrane.

In the process, chlorine gas is produced at the anode and hydrogen gas at the cathode. This results from the reduction of water at the cathode to form hydroxyl ions and hydrogen gas, and the oxidation of chloride ions from sodium chloride solution at the anode to produce chlorine gas. Depending upon the structure of the chlorine membrane electrochemical cell, various undesirable compounds are also produced. For example, the presence of multivalent cation impurities in the brine feed, e.g., calcium and magnesium ions, insoluble materials are formed that foul the membrane. In addition, sodium hydroxide produced during the electrolysis reacts with the chlorine being produced to form sodium hypochlorite and sodium chlorate in the anode compartment. Methods for the reduction of sodium hypochlorite and sodium chlorate from the anode compartment are known. However, what is needed in the art is a method for removing organic deposits of undesirable organic by-products that also develop during the production of chlorine in a chlorine membrane electrochemical cell.

### SUMMARY

The present disclosure provides a method comprising contacting a component of a chlorine membrane electrochemical cell, the component having an organic deposit, for example, a chlorinated organic compound, coated thereon, with a cleaning solution comprising a solvent for the organic deposit for an amount of time, for example, ten minutes to one hour, e.g., 15 minutes, to remove the organic deposit from the component, with the proviso that the component is not a membrane. The solvent can have a boiling point in the range of 175° C. to 300° C. The solvent can also have a water solubility in the range of 0.5 weight % to 7 weight %. The component of a chlorine membrane electrochemical cell is contacted with the solvent at a temperature in the range of 10° C. to 50° C., such as for example ambient temperature as defined herein.

The solvent can comprise diethylene glycol n-butyl ether acetate, ethylene glycol n-butyl ether acetate, or a combination thereof. The cleaning solution may further comprise an additional ingredient, for example, a hydrocarbon, a glycol diether, a high boiling point ketone, or a combination thereof

The method may also include contacting the component with a condensate flush solution, for example, a solution having distilled water.

In yet another embodiment, the component of the chlorine membrane electrochemical cell is an anode compartment component, such as an anode, a baffle, an interior surface, an anode outlet nozzle, a gas-liquid separation chamber, a de-foaming structure, a downstream pipe, equipment associated with the anode compartment, and any combination thereof.

Certain embodiments of the method of the present disclosure further include, as an option, recycling the cleaning solution.

The present disclosure also provides a method for cleaning a component of an anode compartment of a chlorine membrane electrochemical cell, such as a gas-liquid separation chamber, a de-foaming structure, or a combination thereof, the component having a coating of chlorinated-organic deposit disposed thereon, the method comprising contacting the component with a cleaning solution having a solvent for the chlorinated-organic deposit for an amount of time, for example, about 15 minutes, to remove the coating from the component, thereby providing a cleaned component. In certain embodiments of the method, the solvent includes diethylene glycol n-butyl ether acetate, ethylene glycol n-butyl ether acetate, or a combination thereof. In one embodiment, the contacting occurs at an ambient temperature.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic view of an exemplary system for the production of chlorine having a chlorine membrane electrochemical cell.

FIG. 2 is a schematic view illustrating an exemplary chlorine membrane electrochemical cell.

FIG. 3 is a flow chart illustrating a method according to the present disclosure.

FIG. 4 is a photograph depicting the anode compartment of a chlorine membrane electrochemical cell coated with an organic deposit.

FIG. 5 is a photograph depicting the anode compartment of a chlorine membrane electrochemical cell coated with an organic deposit prior to a method according to the present disclosure.

FIG. 6 is a photograph depicting the anode compartment of a chlorine membrane electrochemical cell coated with an organic deposit prior to a method according to the present disclosure.

FIG. 7 is a photograph depicting the anode compartment of a chlorine membrane electrochemical cell of FIG. 4 showing the coating of organic deposit remaining following wash with the control cleaning solution.

FIGS. 8a and 8b are photographs depicting the anode compartment of the chlorine membrane electrochemical cell of FIG. 5 following a method according to the present disclosure.

FIGS. 9a and 9b are photographs depicting the anode compartment of the chlorine membrane electrochemical cell of FIG. 6 following a method according to the present disclosure.

### DETAILED DESCRIPTION

### I. Definitions.

“Chlorine membrane electrochemical cell” refers to an electrochemical cell that utilizes a membrane as a separator and is used for the electrolysis of aqueous salt solutions, for example, alkali metal chloride salt solutions, in the production of chlorine and alkali metal hydroxide, i.e., a chlor-alkali cell, but is not to be limited thereto. One example of a chlorine membrane electrochemical cell is a two-compartment electrochemical cell having components including an anode compartment containing an anode, a cathode compartment containing a cathode, wherein the two compartments are separated by a membrane. Thus, the phrase “component of a chlorine membrane electrochemical cell” refers to a portion of the chlorine membrane electrochemical cell, such as parts of the anode compartment, including for example but not limited to the anode compartment and parts thereof. The phrase “component of a chlorine membrane electrochemical cell” excludes the membrane. The phrase “component of a chlorine membrane electrochemical cell” also excludes the cathode compartment and parts thereof.

“Organic deposit” refers to an undesirable organic by-product generated during the production of chlorine using a chlorine membrane electrochemical cell. The phrase is meant to include both organic and chlorinated-organic compounds, i.e., compounds containing carbon, that accumulate on surfaces of components of the chlorine membrane electrochemical cell, for example, in and around the surfaces of the anode compartment of the chlorine membrane electrochemical cell. The organic deposit is a solid substance that accumulates on the surface of the chlorine membrane electrochemical cell, and is not soluble in the anolyte. For example, the organic deposit does not include sodium hypochlorite or sodium chlorate.

As discussed herein, the phrase “organic deposit” includes both organic and chlorinated-organic deposit material. The organic deposit material can form a coating or layer on a surface of a component of the chlorine membrane electrochemical cell, such as the anode compartment. The terms “coating” and “layer,” as used herein, are synonymous and pertain to the application of a layer of a constituent or set of constituents to another, such as to a substrate or to a coating layer on a substrate. The organic deposit material may be coated from a liquid mixture comprising a liquid carrier medium and the solid materials of the layer which are dissolved or dispersed in the liquid carrier medium. In addition, the organic deposit material can include chlorinated organic compounds that can form a chlorinated organic tar substance, which is a complex mixture of relatively high molecular weight aliphatic compounds, e.g., in the range of C₁₀₀ₛ aliphatic compounds. These high molecular weight aliphatic compounds do not have a sufficiently high vapor pressure to be discharged with the chlorine from the chlorine membrane electrochemical cell.

“Membrane” as used herein means any sheet-like membrane used in an electrolytic cell for separating the chlorine membrane electrochemical cell into two compartments, i.e., the anode compartment and the cathode compartment.

### II. Chlorine Membrane Electrochemical Cells of the Present Disclosure

Any number of commercially available chlorine membrane electrochemical cells may be cleaned according to the methods of the present disclosure. Commercially available chlorine membrane electrochemical cells may be employed in the method of the present invention, for example, those available from Asahi Kasei Chemical Corporation such as ML-32, ML-60NCS, ML-60NCH and ML-60-NCHZ.

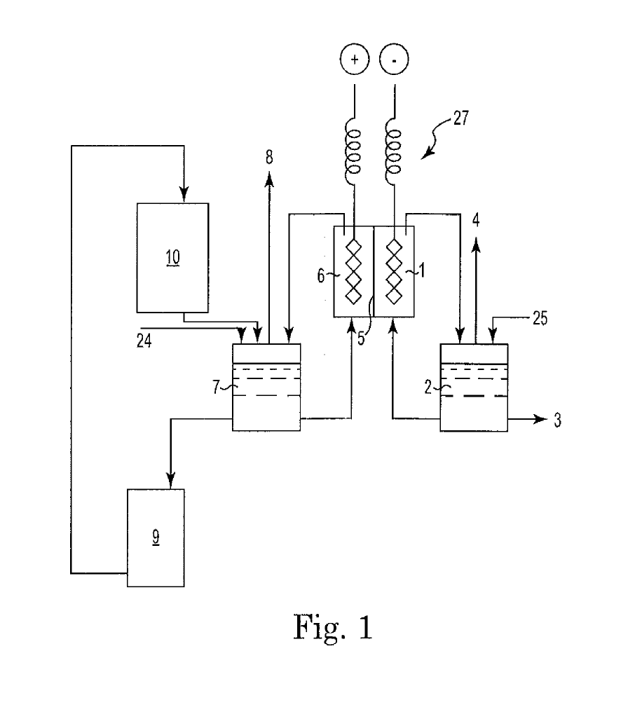

Referring to FIG. 1, one example of a system for the production of chlorine using an exemplary chlorine membrane electrochemical cell 27 is depicted. As shown in the drawing, chlorine membrane electrochemical cell 27 contains cathode compartment 1 and anode compartment 6 separated by cation exchange membrane 5.

The cation exchange membrane can be, for example, any suitable commercially available cation exchange membranes of fluoropolymer ion exchange material that is capable of transporting electrolysis ions while being hydraulically impermeable. Suitable membranes include perfluorinated ion-exchange membranes such as ACIPLEX™ material membranes manufactured by Asahi Kasei Chemical Corporation, DUPONT™ NAFION® material membranes manufactured by E. I. duPont de Nemours and Company and FLEMION® material membranes manufactured by Asahi Glass Company.

The system further includes an aqueous solution of sodium hydroxide (NaOH) that is circulated between cathode chamber 1 and catholyte tank 2. The aqueous solution of NaOH separated in catholyte tank 2 is discharged at outlet line 3, and likewise hydrogen gas separated in tank 2 is discharged through outlet line 4.

The anolyte is circulated between chamber 6 and anolyte tank 7. Chlorine gas separated in tank 7 is discharged through outlet 8 and, likewise, dilute aqueous NaCl solution separated therein is discharged and sent to a dechlorination vessel 9. Further optional processing steps can be included, for example, brine processing 10. Purified, substantially saturated aqueous NaCl solution is fed to anolyte tank 7. Line 24 to anolyte tank 7 is used to feed hydrochloric acid, if necessary, to control the pH therein and line 25 to catholyte tank 2 is likewise used to feed water, if necessary, to control the concentration of the product NaOH.

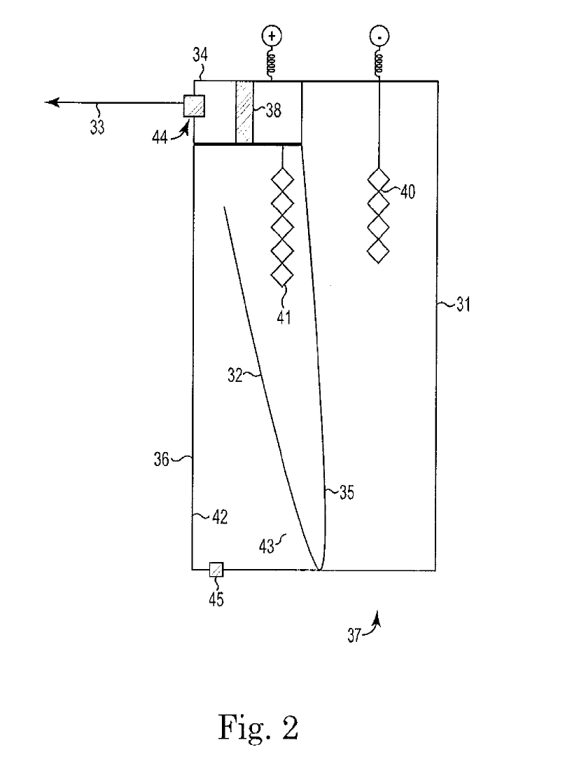

Turning now to FIG. 2, an exemplary chlorine membrane electrochemical cell is depicted in more detail. As shown in the drawing, chlorine membrane electrochemical cell 37 contains cathode compartment 31, which contains cathode 40, and anode compartment 36, which contains anode 41, separated by cation exchange membrane 35. Chlorine gas generated during the electrolysis is discharged from anode compartment 36 through gas-liquid separation chamber 34, and then transferred through downstream piping 33 to an outlet (not shown).

The material of the components of the chlorine membrane electrochemical cell can be any well-known material used for such purposes, for example, metallic or coated with a metallic material. For example, if the electrode used is an anode, the material may be titanium. The anode is in one example a rectangular titanium mesh material. The cathode is, for example, a rectangular nickel mesh material. In addition, the electrodes, i.e., the anode 41 and cathode 40, may include a single member or a plurality of members defining the respective electrode in the chlorine membrane electrochemical cell. The electrode can be solid, punched plate, expanded mesh or wire screen. The electrode can have a variety of desired shapes. For example, the electrode is rectangular in shape.

As mentioned herein, the electrode and/or electrode compartment of the chlorine membrane electrochemical cell may be coated with a suitable electro-conducting electrocatalytically active material. For example, where the electrode is to be used as an anode, the anode may be coated with one or more platinum group metals, that is, platinum, rhodium, iridium, ruthenium, osmium or palladium and/or an oxide of one or more of these metals. The coating of platinum group metal and/or oxide may be present in an admixture with one or more non-noble metal oxides, particularly one or more film-forming metal oxides, e.g., titanium dioxide. Electro-conducting electrocatalytically active materials for use as anode coatings in an electrolytic cell, particularly a cell for the electrolysis of aqueous alkali metal chloride solution, and methods of application of such coatings, are well known in the art.

As discussed herein, during operation of the chlorine membrane electrochemical cell 37, chlorine ions are oxidized electrochemically at the anode 41 to form chlorine gas in the anode compartment 36. Chlorine gas generated in anode compartment 36 leaves the chlorine membrane electrochemical cell 37 through gas-liquid separation chamber 34, de-foaming structure 38, and downstream piping 33. The generated chlorine gas is separated from the aqueous brine solution in gas-liquid separation chamber 34.

In addition to chlorine gas, deposits of undesirable organic by-products form during the production of the chlorine gas. Precursors of the undesirable organic by-products include, but are not limited to, benzene, ethyl benzene, toluene, naptha, and heavier hydrocarbon components, which are introduced into the chlorine membrane electrochemical cell via the brine. These precursors are chlorinated in the chlorine membrane electrochemical cell and provide the undesirable organic deposit, which as discussed above can form a coating including a chlorinated organic tar substance on surfaces in and around the anode compartment of the chlorine membrane electrochemical cell. The phrase “surfaces in and around the anode compartment” is meant to include, but is not limited to, surfaces in and around a component of the anode compartment 36, e.g., surfaces in and around the anode 41, any and all interior surfaces of the anode compartment such as side wall 42 and back wall 43, surfaces in and around the anode inlet nozzle 45, anode outlet nozzle 44, baffle 32, surfaces around a removable gasket surrounding the anode compartment (not shown). In addition, “surfaces in and around the anode compartment” refers to surfaces in and around the gas-liquid separation chamber 34 including de-foaming structure 38, and surfaces in and around equipment associated with the anode compartment such as downstream piping 33. As discussed herein, the organic deposit includes both organic and chlorinated-organic deposit material. For example, the chlorinated-organic deposit may include a chlorinated-organic tar substance, which is a complex mixture of relatively high molecular weight aliphatic compounds, e.g., in the range of C₁₀₀ₛ aliphatic compounds. Such high molecular weight aliphatic compounds do not have a sufficiently high vapor pressure to be discharged with the chlorine from the chlorine membrane electrochemical cell.

Given the metallic composition of components of the anode compartment, as discussed herein, the coating of organic deposit is “visibly discernable” on the surfaces in and around the anode compartment. By “visibly discernable” is meant that the coating of the organic deposit has a different physical appearance than the un-coated surfaces, e.g., clean surfaces, in and around the anode compartment. For example, the coating of organic deposit may be apparent to the naked eye as a white to off-white or whitish-grey colored coating upon the anode, which when un-coated or clean appears relatively dark in color given its metallic composition. The coating may also appear slightly yellow due to the nature of the chlorinated nature of the organic deposit.

### III. Method of the Present Disclosure

According to the method of the present disclosure, the coating of organic deposit that accumulates on the components of a chlorine membrane electrochemical cell during chlorine production is removed. As discussed herein, “components” is meant to include, but is not limited to, the surfaces in and around the anode compartment of a chlorine membrane electrochemical cell. However, the term “components” does not refer to the membrane, i.e., the membrane is not contacted with the cleaning solution in the method of the present disclosure, nor does the term “components” include the cathode compartment or parts thereof. By “cleaning” and “removing” is meant dissolving or taking-off the organic deposit (coating of organic deposit) from the components, e.g., the surfaces in and around the anode compartment, by contacting the same with the cleaning solution.

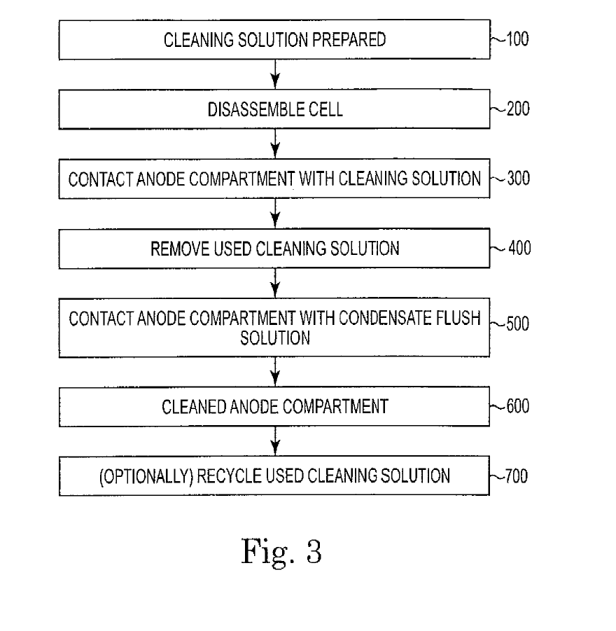

Referring now to FIG. 3, the method of the present disclosure involves the preparation of a cleaning solution (100). The cleaning solution comprises a solvent capable of removing the organic deposits from the chlorine membrane electrochemical cell such as surfaces in and around the anode compartment. Suitable solvents will have a high affinity for the organic deposit, and no unintended precipitation of the organic deposit material from the solvent during the cleaning process. For example, a suitable solvent will have an affinity for the organic deposit and a solubility in water such that the organic deposit solubilizes in the cleaning solution and remains in solution while in contact with the cleaning solution, i.e., the organic deposit will not precipitate out of the cleaning solution. A suitable solvent will also have a limited water solubility, such as in the range of 0.5 weight % to 7 weight %. By weight % is meant grams of solvent per grams of total solution. For example, a suitable solvent will have a water solubility of 0.5 weight % to 2 weight %. In addition, suitable solvents have low odor impact, low volatility, and a relatively high boiling point such as in the range of 175° C. to 300° C., e.g., in the range of 200° C. to 250° C.

Exemplary solvents include diethylene glycol n-butyl ether acetate (CAS 114-17-4), ethylene glycol n-butyl ether acetate (CAS 112-07-2), or a combination thereof. Additionally, solvents may include DOWANOL™ DPM, DOWANOL™ DPMA, dibasic esters, glycol ethers, glycol ether esters, and/or derivatives thereof.

The cleaning solution may include an additional ingredient such as a hydrocarbon, a glycol diether such as PROGLYDE™ DMM (dipropylene glycol dimethyl ether), a high boiling point ketone, such as 2,6,8-trimethyl-4-nonanone or isophorone. For example, the hydrocarbon can include an odorless mineral spirit. In another example, the hydrocarbon has a boiling point similar to that of the solvent. In yet another example, the hydrocarbon is Isopar K, Norpar 12, or a combination thereof.

In certain examples of the method, the cleaning solution does not include an acid, such as HCl or lactic acid.

Referring again to FIG. 3, the chlorine membrane electrochemical cell is disassembled (200). For example, the chlorine membrane electrochemical cell is removed from the system, the anode compartment is separated from the chlorine membrane electrochemical cell, and the membrane and gasket are removed. Components of the chlorine membrane electrochemical cell, with the proviso that the components do not include the membrane or the cathode compartment or parts thereof, are placed in a cleaning apparatus (400). In one example, the anode compartment is contacted with the cleaning solution prepared in step 100 for an amount of time (300). In one example, the amount of time is from five minutes to one hour, e.g., from 10 minutes to 45 minutes. In other examples, the amount of time is about fifteen minutes, about twenty minutes, or about thirty minutes. In another example, the contacting occurs without circulation or agitation, i.e., the component of the chlorine membrane electrochemical cell is soaked in the cleaning solution.

In one example, the method is carried out at a temperature in the range of 10° C. to 50° C. In another example of the method, the method does not include adjusting the temperature, i.e., applying or removing heat to the chlorine membrane electrochemical cell and/or components thereof undergoing cleaning. For example, the method is carried out at an ambient temperature, for example, from 25° C. to 27° C. In one example of the method, the pH is not adjusted by the addition of acid or base.

The used cleaning solution is removed, e.g., drained or pumped, from the cleaning apparatus. The components of the chlorine membrane electrochemical cell undergoing cleaning are then contacted with a condensate flush solution. In one example, the condensate flush solution includes distilled water or purified water. The condensate flush solution rinses any remaining used cleaning solution from the contacted surfaces (500). A cleaned chlorine membrane electrochemical cell is provided (600). As an option, the used cleaning solution is recycled according to methods known in the art (700).

The present disclosure may be better understood with reference to the following examples. These examples are intended to be representative of specific embodiments of the disclosure, and are not intended as limiting the scope of the disclosure.

### EXAMPLES

### Example 1

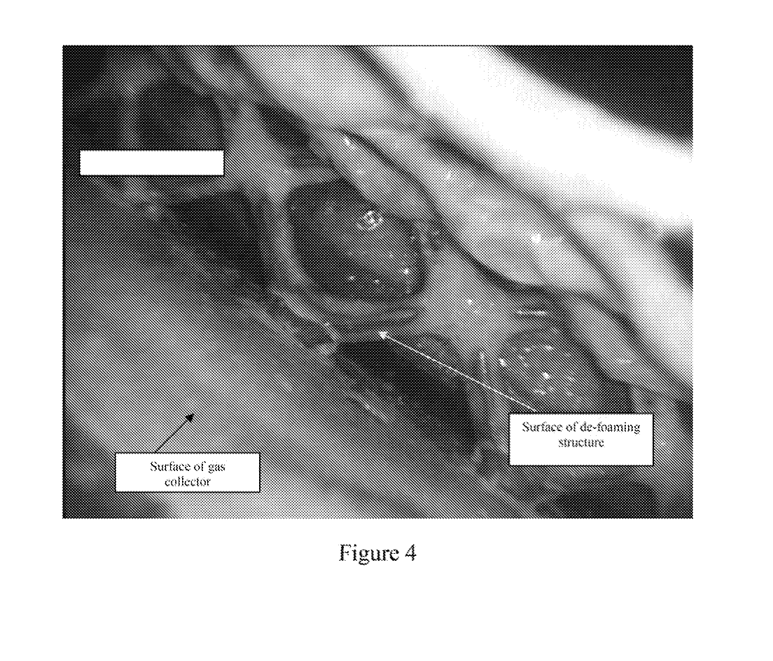

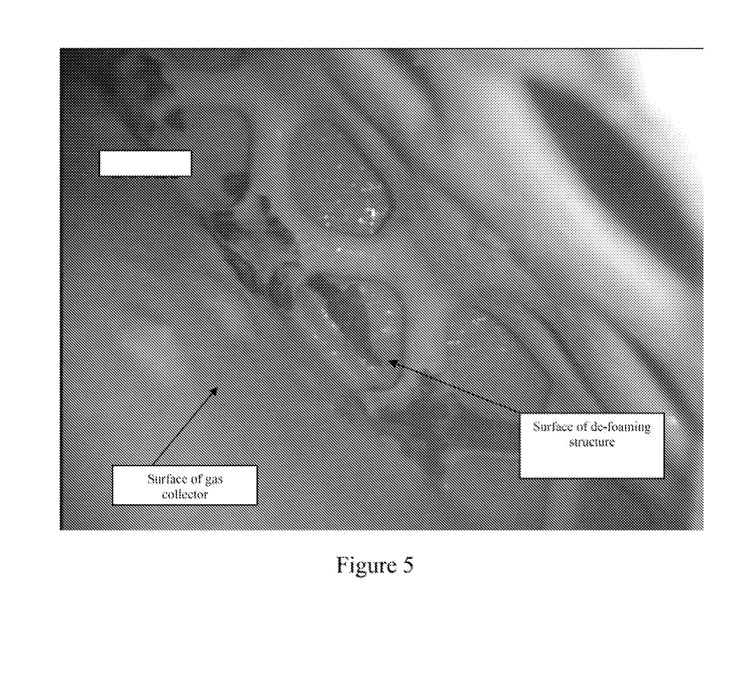

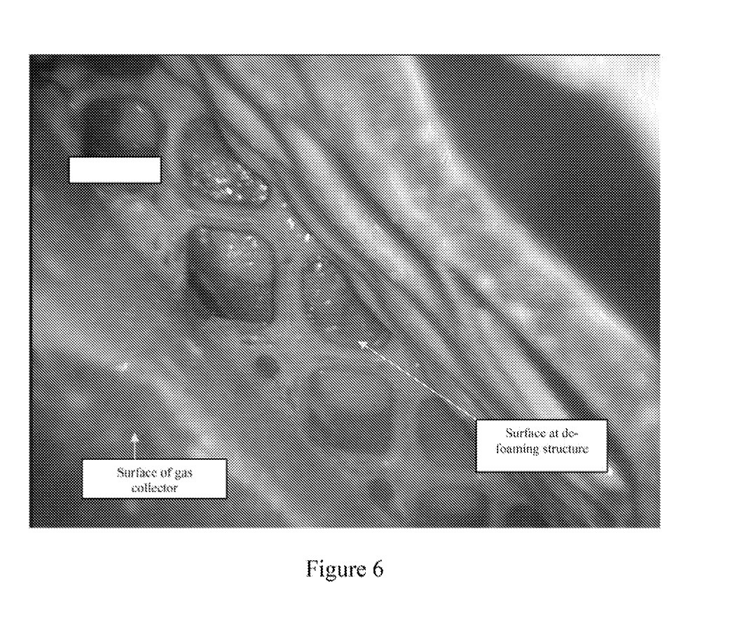

A prototype cleaning apparatus with a turning stand was prepared to clean the anode compartment of three chlorine membrane electrochemical cells (model number ML-60, commercially available from Asahi Kasei Chemicals). Each of the three chlorine membrane electrochemical cells had been used in chlorine production and contained a visibly detectable coating of organic deposit on the anode compartment of the chlorine membrane electrochemical cell, including components such as the gas-liquid separation chamber and de-foaming structure. The coating ranged from a light to very heavy whitish to whitish-grey colored coating (FIGS. 4-6).

Four test cleaning solutions were prepared: Cleaning Solution A was 100% ethylene glycol butyl ether acetate (commercially available from The Dow Chemical Company); Cleaning Solution B was 100% PROGLYDE™ (commercially available from The Dow Chemical Company); Cleaning Solution C was a control solution of 100% water; Cleaning Solution D was 100% diethylene glycol n-butyl ether acetate (commercially available from The Dow Chemical Company).

The chlorine membrane electrochemical cell was separated and the membrane and gasket removed. The anode compartment was placed in the turning stand of the cleaning apparatus and rotated so that the gas-liquid separation chamber was at the lowest elevation.

For cleaning solutions A and B, the anode compartment was filled with the cleaning solution, i.e., the interior of the anode compartment was completely immersed in cleaning solution. The cleaning solution contacted the chlorine membrane electrochemical cell for a period of time, for example, 10 minutes, 20 minutes, 30 minutes, and then drained. Following removal of the cleaning solution, the anode compartment was flushed with a continuous stream of a condensate flush solution, which was 100% distilled water, for five to thirty minutes.

Cleaning Solution C, e., the control solution, was applied to the anode compartment using a high pressure mechanical spray device. In particular, surfaces of the anode compartment were washed with three passes of the device at 2,800 psi, with the exception of the gas-liquid separation chamber which was washed with three passes of the device at 10,000 psi.

Prior to introduction into the cleaning apparatus, Cleaning Solution B appeared as a clear, colorless solution. Used Cleaning Solution B appeared light-yellow in color.

Prior to introduction into the cleaning apparatus, Cleaning Solution A appeared as a clear, colorless solution. Used Cleaning Solution A appeared dark-yellow in color.

A fiber optic camera inserted into the anode outlet nozzle was used to image surfaces of the gas-liquid separation chamber prior to and following the application of each Cleaning Solution.

### Results

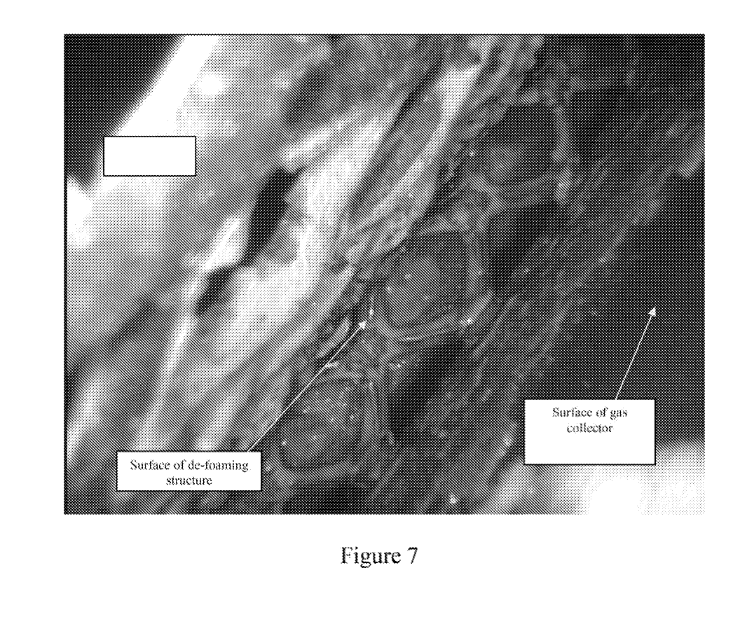

Visible inspection of the cell cleaned with Cleaning Solution C revealed that a light to moderate coating of organic deposit material remained on surfaces of the gas-liquid separation chamber and de-foaming structure following the cleaning procedure (compare FIG. 4 taken prior to the cleaning procedure with FIG. 7, taken after the cleaning procedure). Pressure washing with water did not completely remove the coating of organic deposit material that had accumulated on the chlorine membrane electrochemical cell during the production of chlorine. However, pressure washing was found to remove thick masses of organic deposit material, i.e., “chunks,” as well as areas of loosely adhered organic deposit material from the surfaces of the chlorine membrane electrochemical cell.

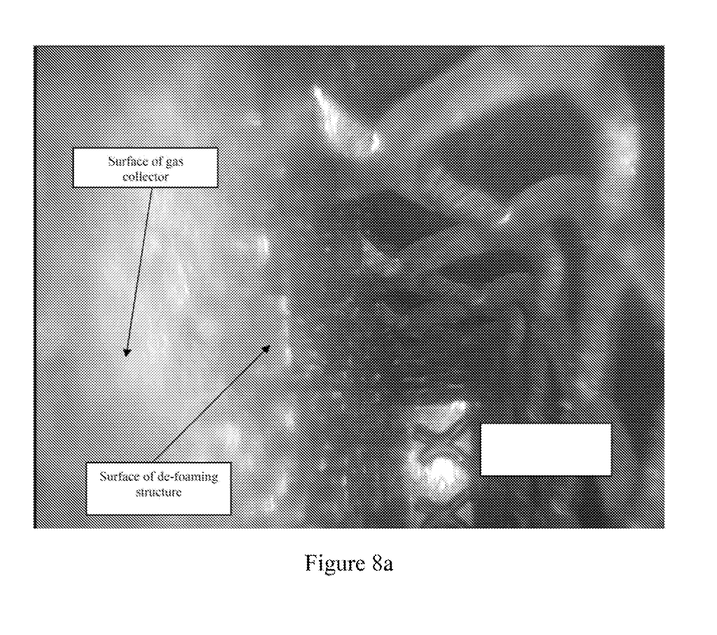

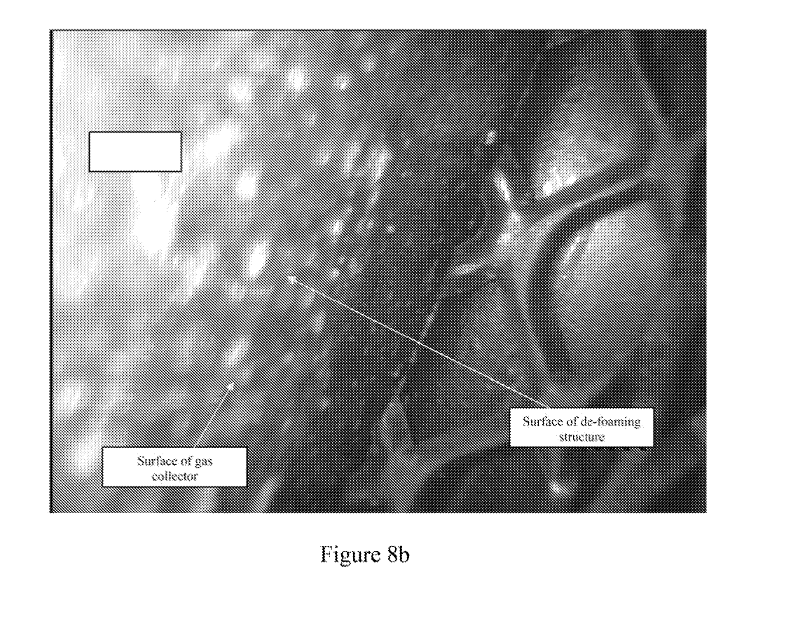

Visible inspection of the cell cleaned with Cleaning Solution B revealed that after 10 minutes, the solvent action was visibly detectable, very little to no coating of organic deposit material remained on the de-foaming structure and gas collector (FIG. 8a). After 30 minutes, Cleaning Solution B had completely dissolved all visible organic deposit material, the de-foaming structure and gas collector appeared clean (FIG. 8b). Cleaning Solution B removed most of the organic deposit coating after the initial 10 minute soak time. After less than 20 minutes, the cell appeared clean.

Organic deposit material was found to precipitate out of solution from Cleaning Solution B when in the presence of water.

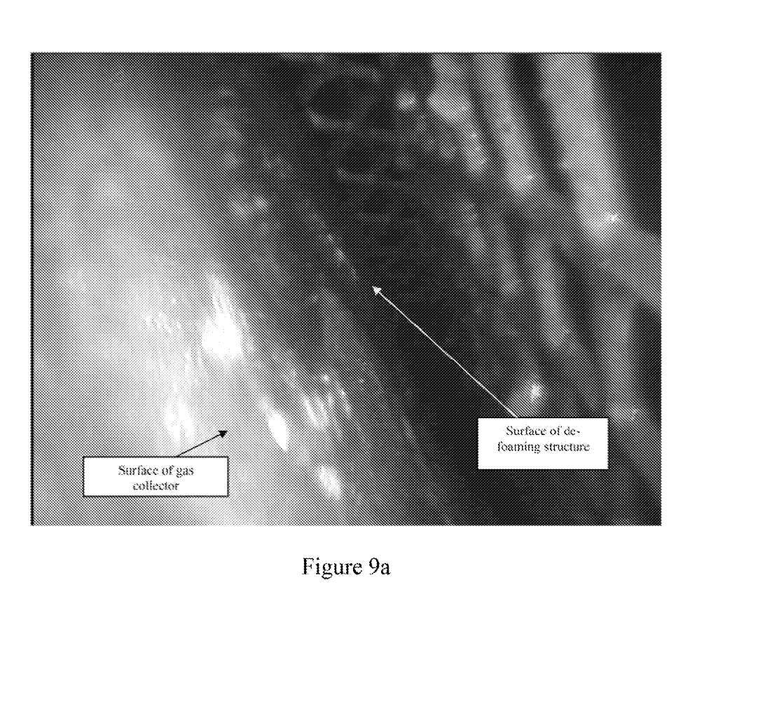

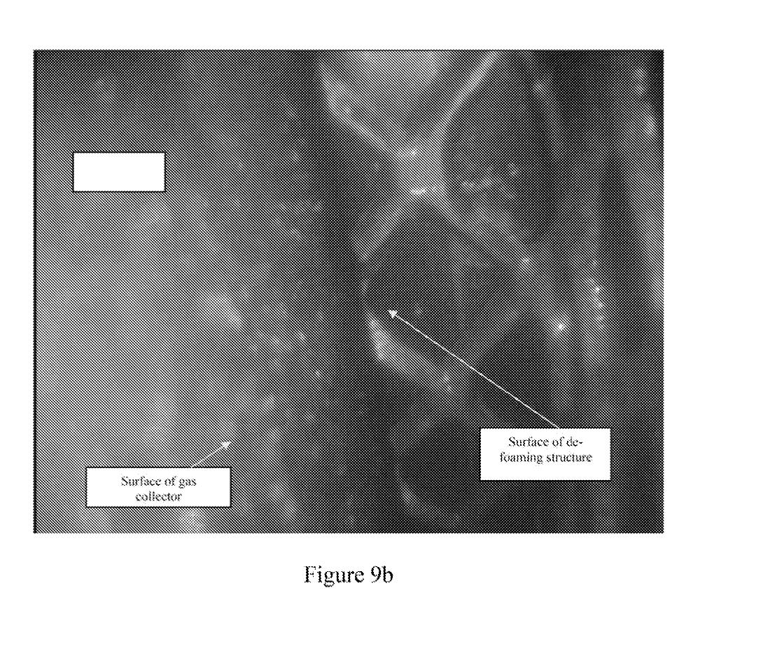

Visible inspection of the cell cleaned with Cleaning Solution A revealed that after 10 minutes, the solvent action was visibly detectable, very little to no coating of organic deposit material remained on the de-foaming structure and gas collector (FIG. 9a). After 20 minutes, Cleaning Solution A had completely dissolved all visible organic deposit material, the de-foaming structure and gas collector appeared clean (FIG. 9b). Cleaning Solution A removed most of the organic deposit coating after about 10 minutes of soak time. After less than 20 minutes, the cell appeared clean. Cleaning Solution A vapor was found to remove organic deposit coating from additional components of the chlorine membrane electrochemical cell, for example, organic deposit coating was removed around the area of the cell gasket without immersion in Cleaning Solution A. Once dissolved in Cleaning Solution A, the organic deposit material did not precipitate during the rinse.

Cleaning Solution D was tested and found to dissolve the solid organic deposit material that had been removed from the cells during the experiment. Once dissolved in Cleaning Solution D, the organic deposit material did not precipitate during the rinse.

1. A method comprising contacting a component of a chlorine membrane electrochemical cell, the component having an organic deposit that includes a chlorinated organic compound coated thereon, with a cleaning solution comprising a solvent that includes diethylene glycol n-butyl ether acetate, ethylene glycol n-butyl ether acetate, or a combination thereof for the organic deposit for an amount of time to remove the organic deposit from the component, with the proviso that the component is not a membrane.

2. (canceled)

3. The method of claim 1, wherein the solvent has a boiling point in the range of 175° C. to 300° C.

4. The method of claim 1, wherein the solvent has a water solubility in the range of 0.5 weight % to 7 weight %.

5. The method of claim 1, wherein the contacting occurs at a temperature in the range of 10° C. to 50° C.

6. The method of claim 5, wherein the temperature is ambient temperature.

7. The method of claim 1, wherein the amount of time is in the range of ten minutes to one hour.

8. The method of claim 7, wherein the amount of time is about 15 minutes.

9. (canceled)

10. The method of claim 1, wherein the cleaning solution further comprises an additional ingredient comprising a hydrocarbon, a glycol diether, a high boiling point ketone, or a combination thereof.

11. The method of claim 1, comprising further contacting the component with a condensate flush solution.

12. The method of claim 11, wherein the condensate flush solution comprises distilled water.

13. The method of claim 1, wherein the component is an anode compartment component.

14. The method of claim 13, wherein the anode compartment component is an anode, a baffle, an interior surface, an anode outlet nozzle, a gas-liquid separation chamber, a de-foaming structure, a downstream pipe, equipment associated with the anode compartment, and any combination thereof.

15. The method of claim 1, further comprising recycling the cleaning solution.
